(19) United States
(12) Patent Application Publication
(10) Pub. No.: US 2014/0158301 A1
(43) Pub. Date: Jun. 12, 2014

(54) VACUUM PROCESSING DEVICE AND VACUUM PROCESSING METHOD

(71) Applicant: ULVAC, Inc., Chigasaki-shi (JP)

(72) Inventors: Ken MAEHIRA, Chigasaki-shi (JP); Taichi SUZUKI, Chigasaki-shi (JP); Eriko MASE, Chigasaki-shi (JP); Koh FUWA, Chigasaki-shi (JP)

(73) Assignee: ULVAC, Inc., Chigasaki-shi (JP)

(21) Appl. No.: 14/177,627

(22) Filed: Feb. 11, 2014

Related U.S. Application Data
(63) Continuation of application No. PCT/JP2012/070273, filed on Aug. 8, 2012.

(30) Foreign Application Priority Data
Aug. 19, 2011 (JP) 2011-179429

(51) Int. Cl. B01J 3/00

(52) U.S. Cl. CPC B01J 3/006
USPC 156/345.29

(57) ABSTRACT

A vacuum processing device and a vacuum processing method that strongly chuck and hold an insulating substrate when plasma processing is performed are provided. The vacuum processing device includes a vacuum chamber that is grounded; a vacuum evacuation device connected to the vacuum chamber; a chuck device arranged inside the vacuum chamber; a chuck power supply for applying an output voltage to a single-pole type electrode provided in the chuck device; a plasma generation gas introduction device for introducing a plasma generation gas into the vacuum chamber; and a plasma generation portion which converts the plasma generation gas into plasma. An object to be processed is arranged on the chuck device; and the chuck power supply applies an output voltage to the single-pole type electrode while the plasma is being generated inside the vacuum chamber; and the object to be processed is processed by the plasma while the object to be processed is being chucked by the chuck device. An insulating substrate is used as the object to be processed and the chuck power supply applies the output voltage that periodically changes between a positive voltage and a negative voltage to the single-pole type electrode.

### BACKGROUND

The present invention generally relates to a vacuum processing device and a vacuum processing method, and more particularly relates to a chuck device which chucks and holds an insulating substrate.

A chuck device is a device, which applies a voltage to an electrode inside the device and that electrostatically chucks a substrate as an object to be processed. The chuck device is used to place and fix the object to be processed onto a stage inside a vacuum processing chamber when plasma processing is performed on the object to be processed (such as, a semiconductor wafer).

As to the chuck device, there are a single-pole electrode type of which either a positive voltage or a negative voltage is applied to an electrode inside the device, and a dipolar electrode type which has an electrode to which a positive voltage is applied and an electrode to which a negative voltage is applied.

FIG. 2 generally shows a structure of a vacuum processing device including a chuck device which has been conventionally used. Here, a dipolar electrode type chuck device is assumed to be used. The general and conventional vacuum processing device 101 includes a vacuum chamber 111 and a plasma generation portion 120.

A vacuum evacuation device 119 is connected to the vacuum chamber 111; and thus, it is possible to perform vacuum evacuation. An insulting stage 115 is arranged inside the vacuum chamber 111, and the chuck device 140 is arranged on the stage 115. The stage 115 electrically insulates the wall of the vacuum chamber 111 and the chuck device 140. The chuck device 140 includes a dielectric layer 105, a first electrode 103₁ and a second electrode 103₂. The first electrode 103₁ and the second electrode 103₂ are arranged inside the dielectric layer 105. A chuck power supply 116 is electrically connected to the first electrode 103₁ and the second electrode 103₂. It is possible to apply a positive direct-current voltage to the first electrode 103₁ and a negative direct-current voltage to the second electrode 103₂. The vacuum chamber 111 is grounded, and is arranged at a ground potential.

The plasma generation portion 120 includes a tubular plasma generation container 134 and a coil 136 with which the side surface on the outside of the plasma generation container 134 is wound. The bottom face of the plasma generation container 134 is open and the edge of the opening is in contact with the edge of an opening provided in the vacuum chamber 111; and the interior of the plasma generation container 134 and the interior of the vacuum chamber 111 are connected to each other. A plasma generation gas introduction device 121 is connected to the plasma generation container 134; and thus, it is possible to supply a plasma generation gas into the plasma generation container 134. An alternating-current power supply 135 is connected to the coil 136. When the alternating-current power supply 135 passes an alternating current to the coil 136, a high-frequency magnetic field is generated inside the plasma generation container 134. It is possible to ionize the plasma generation gas by the high-frequency magnetic field.

In order to perform vacuum processing with plasma using the vacuum processing device 101 structured as discussed above, initially, the interiors of the plasma generation container 134 and the vacuum chamber 111 are vacuum evacuated by the vacuum evacuation device 119, and its vacuum ambience is maintained.

Then, an object to be processed 106 is transported into the vacuum chamber 111 and is placed on the dielectric layer 105. A chuck power supply 116 is started up; and a positive direct-current voltage is applied to the first electrode 103₁, and a negative direct-current voltage is applied to the second electrode 103₂. A chucking force is exerted between the object to be processed 106 and the dielectric layer 105 by the application of the voltage, as described above.

The principle of chucking by the dipolar electrode type chuck device will now be briefly described with reference to FIG. 3. The dielectric layer 105 is affected by an electric field produced by the first electrode 103₁ and the second electrode 103₂ so as to generate dielectric polarization. Charges are generated on the surface of the dielectric layer 105. As shown in FIG. 3, regarding to the distribution of positive charges and negative charges, a part of the surface of the dielectric layer 105 near the first electrode 103₁ is positively charged, and a part of the surface of the dielectric layer 105 near the second electrode 103₂ is negatively charged. The charges in the surface of the dielectric layer 105 produce an uneven electric field above the dielectric layer 105. The object to be processed 106 is affected by the electric field, and is thereby polarized. Because the electric field is uneven, a gradient force is exerted on a dipole generated by the polarization; and thus, the object to be processed 106 is attracted to the dielectric layer 105 (in an even electric field, the resultant of forces exerted on a dipole is zero newtons).

After the object to be processed 106 and the dielectric layer 105 are chucked, the alternating-current power supply 135 is started up, and an alternating current is passed through the coil 136; and thus, the high-frequency magnetic field is produced inside the plasma generation container 134. When the plasma generation gas introduction device 121 introduces the plasma generation gas into the plasma generation container 134, the plasma generation gas is ionized into plasma by the high-frequency magnetic field. The plasma is diffused from the interior of the plasma generation container 134 to the inside of the vacuum chamber 111, and is in contact with the object to be processed 106 and etches the object to be processed 106.

After the completion of the etching, the application of the voltage by the chuck power supply 116 is terminated; and after the chucking force of the object to be processed 106 and the dielectric layer 105 have disappeared, the object to be processed 106 which has been processed is transferred out of the vacuum chamber 111 and the subsequent object to be processed 106 is placed on the dielectric layer 105.

Problems occur in the above-discussed bipolar type chuck device 140 in that the chuck force is weak because the object to be processed 106 and the dielectric layer 105 are chucked by the gradient force, and it is difficult to set the object to be processed to a desired temperature because thermal conductance is poor even if the dielectric layer 105 is heated or cooled in order to heat or cool the object to be processed 106. See, for example, Japanese Unexamined Patent Application Publication No. 2001-156161.

### SUMMARY OF THE INVENTION

The present invention is made to solve the foregoing problem in the conventional technology. An object of the present invention is to provide a vacuum processing device and a vacuum processing method which can strongly chuck and hold an insulating substrate when plasma processing is performed.

In order to solve the foregoing problem, the present invention is a vacuum processing device that includes a vacuum chamber connected to a ground potential, a vacuum evacuation device connected to the vacuum chamber, a chuck device arranged inside the vacuum chamber, a single-pole type electrode provided in the chuck device, a chuck power supply electrically connected to the single-pole type electrode; and a plasma generation gas introduction device for introducing a plasma generation gas into the vacuum chamber, and a plasma generation portion which generates plasma of the plasma generation. An object to be processed is arranged on the chuck device, wherein the chuck power supply applies a chuck voltage to the single-pole type electrode while the plasma is being generated inside the vacuum chamber and the object to be processed is processed by the plasma while the object to be processed is being chucked by the chuck device. The plasma generation portion is arranged away from the-single pole type electrode; an insulating substrate is used as the object to be processed; and the chuck voltage which periodically changes between a positive voltage and a negative voltage is applied from the chuck power supply to the single-pole type electrode.

The present invention is the vacuum processing device of which a groove is formed in a surface of the chuck device, and a thermally conductive gas supply device for supplying a thermally conductive gas to the groove is connected to the groove.

The present invention is the vacuum processing device of which the chuck power supply is set so as to output the chuck voltage in which a time of application of the positive voltage is equal to or less than a time of application of the negative voltage.

The present invention is the vacuum processing device of which the chuck power supply is set so as to output the positive voltage for at least one second.

The present invention is a vacuum processing method using a vacuum processing device which includes a vacuum chamber connected to a ground potential, a vacuum evacuation device connected to the vacuum chamber, a chuck device arranged inside the vacuum chamber, a single-pole type electrode provided in the chuck device, a chuck power supply electrically connected to the single-pole type electrode, a plasma generation gas introduction device for introducing a plasma generation gas into the vacuum chamber, and a plasma generation portion which generates plasma of the plasma generation gas; and the plasma generation portion is arranged away from the single-pole type electrode, the method including the steps of arranging an object to be processed on the chuck device, while chucking the object to be processed to the chuck device by generating the plasma inside the vacuum chamber and outputting a chuck voltage from the chuck power supply to the single-pole type electrode, and processing the object to be processed by the plasma. The method further comprising the steps of using an insulating substrate as the object to be processed, chucking the object to be processed to the chuck device by making the object to be processed in contact with the plasma and by being output the chuck voltage which periodically changes between a positive voltage and a negative voltage from the chuck power supply so as to apply the chuck voltage to the single-pole type electrode.

The present invention is the vacuum processing method in which the insulating substrate is sapphire.

The present invention is the vacuum processing method in which the chuck voltage is set to a time of application of the positive voltage to equal to or less than a time of application of the negative voltage.

The present invention is the vacuum processing method wherein the time of application of the positive voltage is at least one second.

The present invention is the vacuum processing method wherein, when the object to be processed is processed in vacuum by the plasma, a thermally conductive gas is introduced between a surface of the chuck device and the insulating substrate.

It is possible to increase a chucking force exerted between an object to be processed and a single-pole electrode type chuck device.

### BRIEF DESCRIPTION OF DRAWINGS

FIG. 1 is an internal diagram of the structural arrangement of a vacuum processing device including a single-pole electrode type chuck device according to the present invention.

FIG. 2 is an internal diagram of the structural arrangement of a vacuum processing device including a conventional dipolar electrode type chuck device.

FIG. 3 is a diagram for illustrating the principle of chuck in the dipolar electrode type chuck device.

FIG. 4 is a graph showing the amount of leak of helium when a voltage is applied, the voltage having a positive voltage and a negative voltage and periodically and repeatedly changing.

FIG. 5 is a graph showing a voltage application process effective for maintaining a chucking force and the amount of leak of helium in such a process.

FIG. 6 is a graph showing the dependence of the decrease in the chucking force on plasma.

FIG. 7 is a graph showing a relationship between the voltage application process and the amount of leak of helium.

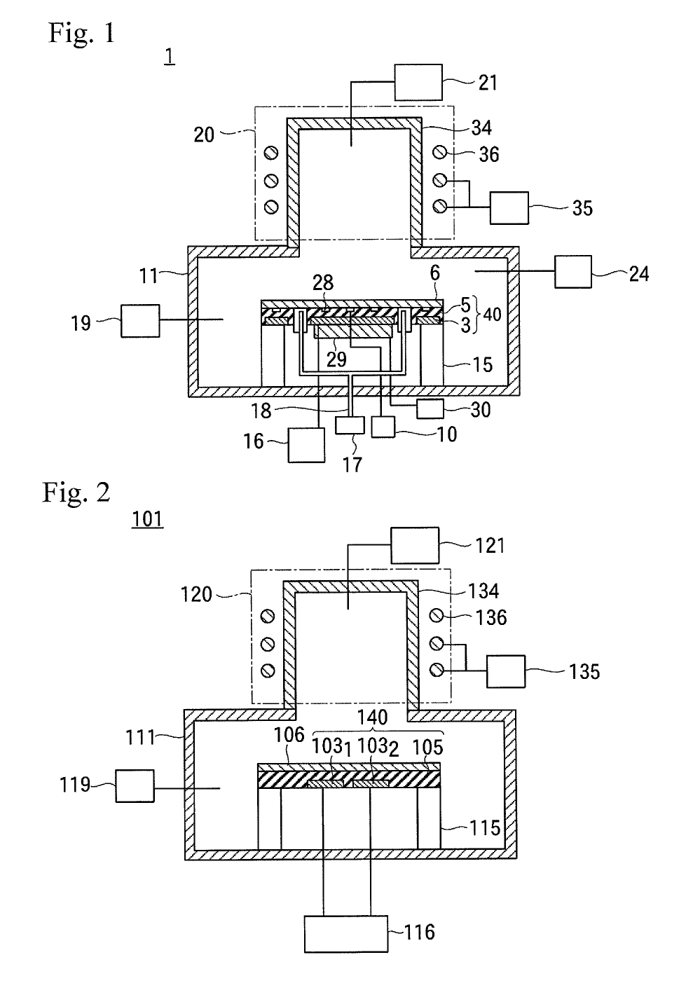

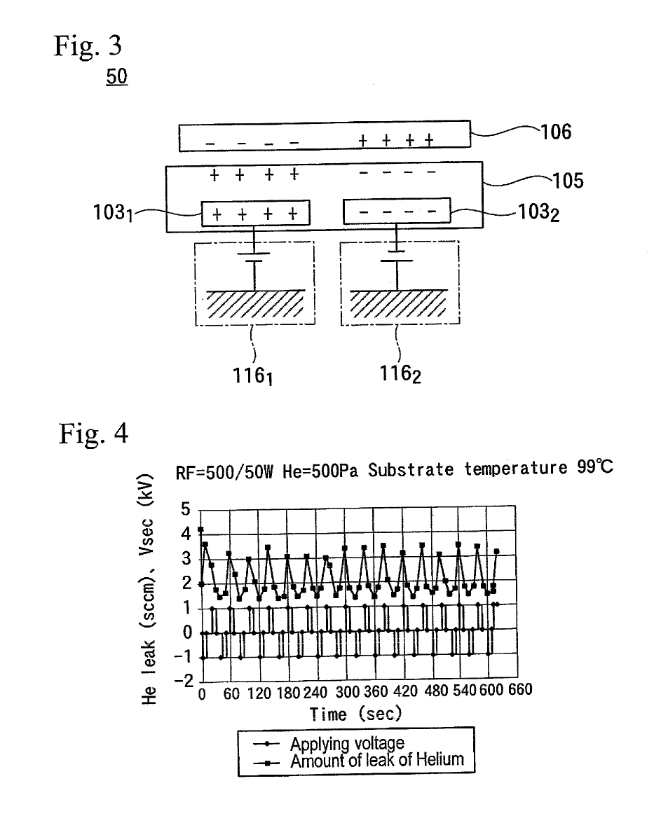

### DETAILED DESCRIPTION OF THE INVENTION

The structure of a vacuum processing device of the present invention will be described with reference to FIG. 1. The vacuum processing device 1 of the present invention includes a metallic vacuum chamber 11 made of metal and a plasma generation portion 20.

A vacuum evacuation device 19 is connected to the vacuum chamber 11; and thus, it is possible to vacuum evacuate inside the vacuum chamber 11. An insulating stage 15 is arranged inside the vacuum chamber 11, and a chuck device 40 is arranged on the stage 15. The stage 15 electrically insulates the wall of the vacuum chamber 11 and the chuck device 40. The vacuum chamber 11 is grounded, and is arranged at a ground potential.

The chuck device 40 includes a dielectric layer 5 and a single-pole type electrode 3. The dielectric layer 5 is arranged on the single-pole type electrode 3. A chuck power supply 16, arranged outside the vacuum chamber 11, is electrically connected to the single-pole type electrode 3. The chuck power supply 16 can change the magnitude and the polarity of an output voltage applied to the single-pole type electrode 3.

The single-pole type electrode 3 can be formed with one conductive electrode plate or may be formed with a plurality of conductive electrode plates.

When the single-pole type electrode 3 is formed with a plurality of electrodes, a voltage having the same polarity and magnitude is applied to all the electrodes. Between the surface of the dielectric layer 5 and the single-pole type electrode 3, an electrode which is applied with voltage having a different polarity or a different magnitude is not arranged.

A rod-shaped substrate raising and lowering element 18 is arranged inside the vacuum chamber 11; and a substrate raising and lowering control device 17 is connected to the substrate raising and lowering element 18. The substrate raising and lowering control device 17 can move the substrate raising and lowering element 18 up and down. Holes are provided in the dielectric layer 5 and the single-pole type electrode 3 in a manner such that the substrate raising and lowering element 18 can protrude from below to above the chuck device 40.

Grooves 28 are provided in the surface of the dielectric layer 5. The grooves 28 are present inside the dielectric layer 5; and the openings of the grooves 28 are located in the surface of the dielectric layer 5. The bottom surface and the side surfaces of the groove 28 are the dielectric layer 5; and both ends of the groove 28 are closed by the dielectric layer 5. When a plate-shaped object to be processed 6 is placed onto the dielectric layer 5, the object to be processed 6 is exposed to the openings of the grooves 28, and the grooves 28 are surrounded by the dielectric layer 5 and the surface of the object to be processed 6 facing downward (hereinafter referred to as a back surface) so as to be closed spaces. A hole is formed in the groove 28; a thermally conductive gas supply device 10 is connected to the hole; and thus, it is possible to supply a thermally conductive gas to the groove 28.

When the thermally conductive gas is supplied in a state such that the object to be processed 6 is placed on the dielectric layer 5, the space surrounded by the dielectric layer 5 and the object to be processed 6 is filled with the thermally conductive gas.

Between the back surface of the object to be processed 6 and the surface of the dielectric layer 5, a gap occurs due to fine unevenness between the object to be processed 6 and the dielectric layer 5. When the thermally conductive gas enters the gap from the space inside the groove 28, the thermally conductive gas makes contact with both the object to be processed 6 and the dielectric layer 5; and thus, heat easily passes between the object to be processed 6 and the dielectric layer 5.

Under the chuck device 40, a temperature adjustment unit 29 is arranged in contact with the chuck device 40; and a thermal power supply 30 is electrically connected to the temperature adjustment unit 29. When the thermal power supply 30 is started up, the temperature adjustment unit 29 is heated or cooled; and the dielectric layer 5, which is in contact with the temperature adjustment unit 29, is heated or cooled by thermal conductivity. When the dielectric layer 5 is heated or cooled; the thermally conductive gas is heated or cooled by contact with the dielectric layer 5; the thermally conductive gas which has been heated or cooled makes contact with the object to be processed 6; and the object to be processed 6 is heated or cooled.

A thermally conductive gas flow rate measurement device 24 is connected to the vacuum chamber 11. When the object to be processed 6 is placed onto the dielectric layer 5, it is possible to measure the flow rate of the thermally conductive gas leaking between the object to be processed 6 and the dielectric layer 5 by the thermally conductive gas flow rate measurement device 24.

The plasma generation portion 20 includes a tubular plasma generation container 34 and a coil 36 with which the side surface on the outside of the plasma generation container 34 is wound. The bottom face of the plasma generation container 34 is open. The edge of the opening is in contact with the edge of an opening provided in the vacuum chamber 11; and the interior of the plasma generation container 34 and the interior of the vacuum chamber 11 are connected to each other.

A plasma generation gas introduction device 21 is connected to the plasma generation container 34; and thus, it is possible to supply a plasma generation gas into the plasma generation container 34. A plasma generation alternating-current power supply 35 is electrically connected to the coil 36. When an alternating-current is passed through the coil 36 from the plasma generation alternating-current power supply 35, a high-frequency magnetic field (alternating-current magnetic field) is generated inside the plasma generation container 34. The plasma generation gas is ionized by the high-frequency magnetic field inside the plasma generation container 34; and the plasma of the plasma generation gas is generated inside the plasma generation container 34. The individual members of the plasma generation portion 20 are separately arranged from the single-pole type electrode 3.

A procedure for performing vacuum processing using the vacuum processing device 1 having the structure discussed above will be described for plasma processing as an example. In addition, the object to be processed 6 is an insulating substrate; and it is assumed that parts of the object to be processed 6, which should not be removed by plasma, are covered with a thin film of an organic compound.

Here, as the object to be processed 6, sapphire (Al₂O₃), is used. As the object to be processed 6 other than sapphire, gallium nitride (GaN), quartz (SiO₂), silicon carbide (SiC), zinc selenide (ZnSe) or zinc oxide (ZnO) can be used. An insulating substrate covered with a thin film of aluminum gallium arsenide (AlGaAs), gallium arsenide phosphorus (GaAsP), indium gallium nitride (InGaN), aluminum gallium nitride (AlGaN), gallium phosphide (GaP) or aluminum indium gallium phosphide (AlGaInP) can also be used.

The interior of the vacuum chamber 11 and the interior of the plasma generation container 34 are vacuum evacuated by the vacuum evacuation device 19, and its vacuum ambience is maintained.

The substrate raising and lowering control device 17 is started up to have the substrate raising and lowering element 18 protrude above the chuck device 40. While the vacuum ambience inside the vacuum processing device 1 is being maintained, the object to be processed 6 is transferred into the vacuum chamber 11, and is placed onto the substrate raising and lowering element 18. The substrate raising and lowering control device 17 is started and the object to be processed 6 is lowered together with the substrate raising and lowering element 18; and the object to be processed 6 is placed onto the dielectric layer 5.

In order to chuck the object to be processed 6 to the chuck device 40, the chuck power supply 16 is started up; and the chuck voltage is applied to the single-pole type electrode 3. Here, as the chuck voltage, a positive voltage and a negative voltage are alternately applied. Introduction of the thermally conductive gas is started from the thermally conductive gas supply device 10 into the grooves 28; and the thermal power supply 30 is started so as to cool the object to be processed 6. Here, as the thermally conductive gas, helium gas is used. Hereinafter, the flow rate of thermally conductive gas leaking through the gap between the dielectric layer 5 and the object to be processed 6 is continuously measured by the thermally conductive gas flow rate measurement device 24.

In the present invention, a chucking force measurement method using the thermally conductive gas is used. If the object to be processed 6 is strongly chucked to the dielectric layer 5, the flow rate of helium gas leaking through the gap between the object to be processed 6 and the dielectric layer 5 is reduced, whereas if the chucking force is low, the flow rate of helium gas leaking is increased, so that it is possible to measure the chucking force between the object to be processed 6 and the dielectric layer 5 by measuring the flow rate of helium gas that leakes.

The plasma generation alternating-current power supply 35 is started up to pass the alternating current through the coil 36; and the plasma generation gas (etching gas) is introduced from the plasma generation gas introduction device 21 into the plasma generation container 34. The introduced plasma generation gas is ionized by the high-frequency magnetic field so as to generate the plasma. The chucking force is exerted between the chuck device 40 and the object to be processed 6 due to the generated plasma as conductive, and the parts of the object to be processed 6 which are not masked by the thin film of the organic compound are etched by the plasma.

After the termination of the etching, the application of the voltage by the chuck power supply 16 is terminated. After the chucking force between the object to be processed 6 and the chuck device 40 has disappeared, the substrate raising and lowering control device 17 is operated, and the object to be processed 6 is raided and separated from the dielectric layer 5. The object to be processed 6 is transferred out of the vacuum chamber 11; and the subsequent object to be processed 6 is transferred into the vacuum chamber 11 and is placed onto the substrate raising and lowering element 18.

Here, the plasma generation portion 20 is configured so as to form the alternating-current magnetic field inside the vacuum chamber 11 to generate the plasma inside the plasma generation container 34 (inductive coupling system). However, it is possible to configure a pair of electrodes that is arranged inside the vacuum chamber or the plasma generation container, and high-frequency voltages of opposite polarities (alternating-current voltages) that are applied to the two electrodes which are arranged as a pair so as to perform discharge and generate plasma (RF system), or direct-current voltages having opposite polarities that are applied to a pair of electrodes arranged inside the vacuum chamber or the plasma generation container so as to perform discharge and generate plasma (DC system).

Although the vacuum processing device 1 of FIG. 1 is utilized for etching, the vacuum processing device 1 can also be used not only for etching but also for cleaning, activation and film formation.

### EXAMPLES

### Example 1

As the chuck voltage includes a positive voltage and a negative voltage and periodically changes, the chuck voltage being applied to the above-discussed single-pole type electrode 3, a voltage which switches from negative, zero, positive and zero every 10 seconds is applied to the single-pole type electrode 3. FIG. 4 shows results obtained by measuring variations in the amount of leak of helium at this time. As shown in FIG. 4, when the applied chuck voltage is made positive, the amount of leak of helium (the flow rate of helium gas leaking) is increased and the chucking force is decreased, whereas when the applied output voltage is made negative, the amount of leak of helium is decreased and the chucking force is recovered. In other words, as shown, it is possible to perform continuous chucking by periodically applying the output voltage, as discussed above.

### Example 2

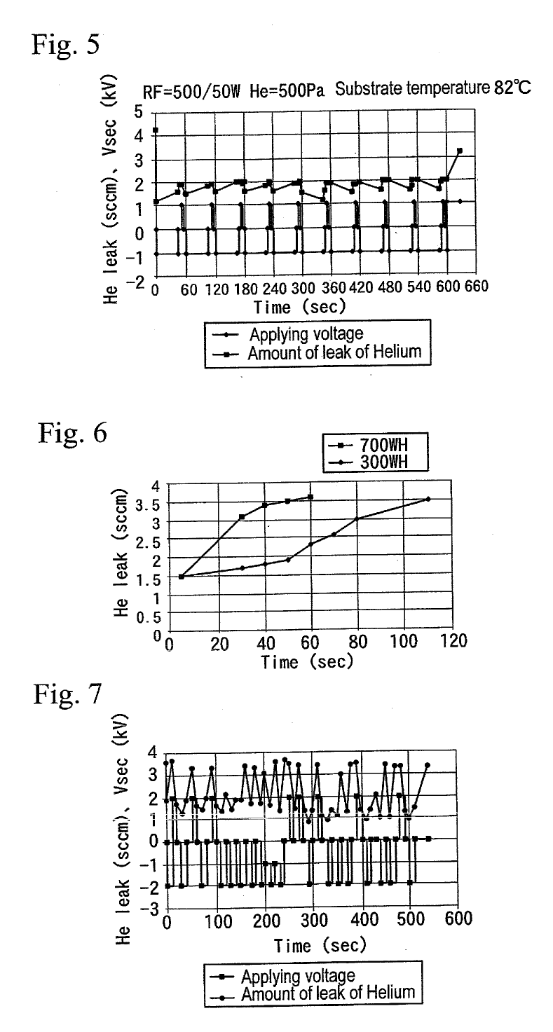

The chuck voltage includes a positive voltage and a negative voltage and periodically changes, the chuck voltage being applied to the above-discussed single-pole type electrode 3 and being repeatedly switched to zero, negative, zero and positive, wherein the time of application of the positive voltage is reduced as compared to the time of application of the negative voltage. Here, the time of application of the positive voltage is set at least 1 second. For example, the times of application of the zero, negative, zero and positive voltages are set to 4.5 seconds, 50 seconds, 4.5 seconds and 1 second, respectively. Measurement data on the amount of leak of helium here is shown in FIG. 5. Although, the amount of leak of helium is increased as the positive voltage is applied because the time of application of the positive voltage in FIG. 5 is short as compared to the case of FIG. 4, the increase in the amount of leak of helium is lower than in the case of FIG. 4. With the voltage application process as discussed above, it is possible to keep the amount of leak of helium lower than in the case of FIG. 4 and thereby maintain a strong chucking force.

It is understood that, as a negative voltage is continuously applied, the chucking force is gradually reduced. Thus, a time for applying a positive voltage is necessary; however, the continuous application of the positive voltage causes the chucking force to be gradually reduced. The necessary time for applying the positive voltage for recovery of the chucking force when the voltage is returned to the negative voltage may be 1 second. After the positive voltage application time of 1 second elapses, the voltage is rapidly returned to the negative voltage; and thus, it is possible to maintain the chucking force.

A periodical voltage application process in which pulses of the positive voltage are applied to the background of the negative voltage (that is, a voltage application process in which the time of application of the positive voltage is shorter than the time of application of the negative voltage and is at least 1 second) is effective for maintaining the chucking force.

### Comparative Example 1

When the output voltage, which includes a positive voltage and a negative voltage and periodically changes and is applied to the above-discussed single-pole type electrode 3, is changed to a negative direct-current voltage, variations in the amount of leak of helium are as shown in FIG. 6. FIG. 6 shows graphs in which powers supplied to the coil 36 are 700 watt-hours and 300 watt-hours, and in both graphs, they show that the amount of leak of helium is increased as time has elapsed (that is, the chucking force between the object to be processed 6 and the chuck device 40 is decreased). Furthermore, the degree of reduction of the chucking force depend on the plasma; and thus, it is understood that as the power supplied to the plasma is greater, the chucking force is reduced faster.

### Comparative Example 2

FIG. 7 shows variations in the amount of leak of helium when the output voltage applied to the single-pole type electrode 3 is changed every 10 seconds. In FIG. 7, during the time from 0 seconds to 100 seconds, zero, negative, zero and positive voltages are repeatedly applied. However, the magnitude of the voltage is twice as great as the magnitude of the voltage in the case of FIG. 4, as discussed above.

As shown in FIG. 4, when the negative voltage or the zero voltage is applied, the amount of leak of helium is small as compared to the application of the positive voltage, and the chucking force is strong whereas when the positive voltage is applied for 10 seconds, the amount of leak of helium is increased, and the chucking force is reduced.

During the time from 100 seconds to 190 seconds, the zero voltage and the negative voltage are alternately applied. When 160 seconds have elapsed, the amount of leak of helium is rapidly increased as compared to the time from 100 seconds to 150 seconds. Thus, it is suggested that the time during which the chucking force can be maintained by the repetition of the zero voltage and the negative voltage is at most 60 seconds, and in order to maintain the chucking force longer, it is necessary to apply the positive voltage.

Consequently, the time of application of the negative voltage is equal to or more than the time of application of the positive voltage, and the time of application of the positive voltage is at least 1 second but less than 10 seconds.

During the time from 190 seconds to 240 seconds, a first negative voltage and a second negative voltage whose absolute value is less than the absolute value of the first negative voltage are alternately applied. It is understood that the amount of leak of helium is increased when the second negative voltage is applied; and the chucking force is not able to be maintained.

During the time from 240 seconds to 280 seconds, the zero voltage and the positive voltage are alternately applied. It is understood that the amount of leak of helium is increased when the positive voltage is applied for 10 seconds, and the chucking force is not able to be maintained. After 280 seconds have elapsed, the positive voltage is applied for 10 seconds out of 80 seconds, and the zero voltage or the negative voltage is applied for the remaining 70 seconds. It is understood that even in this process, it is impossible to suppress the amount of leak of helium, and the chucking force cannot be maintained.

### LIST OF REFERENCE NUMERALS

1 vacuum processing device
3 single-pole type electrode
5 dielectric layer
6 object to be processed
10 thermally conductive gas supply device
11 vacuum chamber
16 chuck power supply
19 vacuum evacuation device
20 plasma generation portion
21 plasma generation gas introduction device
28 groove
40 chuck device

What is claimed is:

1. A vacuum processing device, comprising:
a vacuum chamber connected to a ground potential;
a vacuum evacuation device connected to the vacuum chamber;
a chuck device arranged inside the vacuum chamber;
a single-pole type electrode provided in the chuck device;
a chuck power supply electrically connected to the single-pole type electrode;
a plasma generation gas introduction device for introducing a plasma generation gas into the vacuum chamber; and
a plasma generation portion which generates plasma of the plasma generation,
wherein an object to be processed is arranged on the chuck device, the chuck power supply applying a chuck voltage to the single-pole type electrode while the plasma is being generated inside the vacuum chamber and the object to be processed is processed by the plasma while the object to be processed is being chucked by the chuck device,
wherein the plasma generation portion is arranged away from the-single pole type electrode,
wherein an insulating substrate is used as the object to be processed, and
wherein the chuck voltage, which periodically changes between a positive voltage and a negative voltage, is applied from the chuck power supply to the single-pole type electrode.

2. The vacuum processing device according to claim 1,
wherein a groove is formed in a surface of the chuck device, and
wherein a thermally conductive gas supply device for supplying a thermally conductive gas to the groove is connected to the groove.

3. The vacuum processing device according claim 1,
wherein the chuck power supply is set so as to output the chuck voltage in which a time of application of the positive voltage is at most a time of application of the negative voltage.

4. The vacuum processing device according to claim 3, wherein the chuck power supply is set so as to output the positive voltage for at least one second.

5. A vacuum processing method using a vacuum processing device which includes:
a vacuum chamber connected to a ground potential,
a vacuum evacuation device connected to the vacuum chamber,
a chuck device arranged inside the vacuum chamber,
a single-pole type electrode provided in the chuck device,
a chuck power supply electrically connected to the single-pole type electrode,
a plasma generation gas introduction device for introducing a plasma generation gas into the vacuum chamber, and
a plasma generation portion which generates plasma of the plasma generation gas, and
in which the plasma generation portion is arranged away from the single-pole type electrode,
the method comprising the steps of:
arranging an object to be processed on the chuck device; and
while chucking the object to be processed to the chuck device by generating the plasma inside the vacuum chamber and by outputting a chuck voltage from the chuck power supply to the single-pole type electrode,
processing the object to be processed by the plasma,
the method further comprising the steps of:
using an insulating substrate as the object to be processed; and
chucking the object to be processed to the chuck device by making the object to be processed in contact with the plasma and by outputting the chuck voltage, which periodically changes between a positive voltage and a negative voltage, from the chuck power supply so as to apply the chuck voltage to the single-pole type electrode.

6. The vacuum processing method according to claim 5, wherein the insulating substrate is sapphire.

7. The vacuum processing method according to claim 5, wherein the chuck voltage is set to a time of application of the positive voltage is at most a time of application of the negative voltage.

8. The vacuum processing method according to claim 7, wherein the time of application of the positive voltage is at least one second.

9. The vacuum processing method according to claim 5,
wherein, when the object to be processed is processed in vacuum by the plasma, a thermally conductive gas is introduced between a surface of the chuck device and the insulating substrate.
